(19) United States
(12) Patent Application Publication
(10) Pub. No.: US 2021/0004690 A1
(43) Pub. Date: Jan. 7, 2021

(54) METHOD OF AND SYSTEM FOR MULTI-VIEW AND MULTI-SOURCE TRANSFERS IN NEURAL TOPIC MODELLING

(71) Applicant: Siemens Aktiengesellschaft, München (DE)

(72) Inventors: YATIN CHAUDHARY, München (DE); PANKAJ GUPTA, München (DE)

(21) Appl. No.: 16/458,230

(22) Filed: Jul. 1, 2019

(51) Int. Cl. G06N 5/02; G06N 3/08; G06N 7/00

(52) U.S. Cl. CPC G06N 5/02; G06N 7/005; G06N 3/08

(57) ABSTRACT

The present invention relates to a computer-implemented method of Neural Topic Modelling (NTM), a respective computer program, computer-readable medium and data processing system. Global-View Transfer (GVT) or Multi-View Transfer (MTV, GVT and Local-View Transfer (LVT) jointly applied), with or without Multi-Source Transfer (MST) are utilised in the method of NTM. For GVT a pre-trained topic Knowledge Base (KB) of latent topic features is prepared and knowledge is transferred to a target by GVT via learning meaningful latent topic features guided by relevant latent topic features of the topic KB. This is effected by extending a loss function and minimising the extended loss function. For MVT additionally a pre-trained word embeddings KB of word embeddings is prepared and knowledge is transferred to the target by LVT via learning meaningful word embeddings guided by relevant word embeddings of the word embeddings KB. This is effected by extending a term for calculating pre-activations.

### FIELD OF TECHNOLOGY

The present invention relates to a computer-implemented method of Neural Topic Modelling (NTM) as well as a respective computer program, a respective computer-readable medium and a respective data processing system. In particular, Global-View Transfer (GVT) or Multi-View Transfer (MTV), where GVT and Local-View Transfer (LVT) are jointly applied, with or without Multi-Source Transfer (MST) are utilised in the method of NTM.

### BACKGROUND

Probabilistic topic models, such as LDA (Blei et al., 2003, Latent dirichlet allocation. Journal of Machine Learning Research, 3:993-1022), Replicated Softmax (RSM) (Salakhutdinov and Hinton, 2009, Replicated softmax: an undirected topic model. In Advances in Neural Information Processing Systems 22: 23rd Annual Conference on Neural Information Processing Systems, pages 1607-1614. Curran Associates, Inc.) and Document Neural Autoregressive Distribution Estimator (DocNADE) (Larochelle and Lauly, 2012, A neural autoregressive topic model. In Advances in Neural Information Processing Systems 25: 26th Annual Conference on Neural Information Processing Systems, pages 2717-2725) are often used to extract topics from text collections and learn latent document representations to perform natural language processing tasks, such as information retrieval (IR). Though they have been shown to be powerful in modelling large text corpora, the Topic Modelling (TM) still remains challenging especially in a sparse-data setting (e.g. on short text or a corpus of few documents).

Word embeddings (Pennington et al., 2014, Glove: Global vectors for word representation. In Proceedings of the 2014 Conference on Empirical Methods in Natural Language Processing (EMNLP), pages 1532-1543. Association for Computational Linguistics) have local context (view) in the sense that they are learned based on local collocation pattern in a text corpus, where the representation of each word either depends on a local context window (Mikolov et al., 2013, Distributed representations of words and phrases and their compositionality. In Advances in Neural Information Processing Systems 26: 27th Annual Conference on Neural Information Processing Systems, pages 3111-3119) or is a function of its sentence(s) (Peters et al., 2018, Deep contextualized word representations. In Proceedings of the 2018 Conference of the North American Chapter of the Association for Computational Linguistics: Human Language Technologies, Volume 1 (Long Papers), pages 2227-2237. Association for Computational Linguistics.). Consequently, the word occurrences are modelled in a fine granularity. Word embeddings may be used in (neural) topic modelling to address the above mentioned data sparsity problem.

On other hand, a topic (Blei et al., 2003) has a global word context (view): Topic modelling, TM, infers topic distributions across documents in the corpus and assigns a topic to each word occurrence, where the assignment is equally dependent on all other words appearing in the same document. Therefore, it learns from word occurrences across documents and encodes a coarse-granularity description. Unlike word embeddings, topics can capture the thematic structures (topical semantics) in the underlying corpus.

Though word embeddings and topics are complementary in how they represent the meaning, they are distinctive in how they learn from word occurrences observed in text corpora.

To alleviate the data sparsity issues, recent works (Das et al., (2015), Gaussian lda for topic models with word embeddings. In Proceedings of the 53rd Annual Meeting of the Association for Computational Linguistics and the 7th International Joint Conference on Natural Language Processing (Volume 1: Long Papers), pages 795-804. Association for Computational Linguistics; Nguyen et al., 2015, Improving topic models with latent feature word representations. TACL, 3:299-313; and Gupta et al., 2019, Document informed neural autoregressive topic models with distributional prior. In Proceedings of the Thirty-Third AAAI Conference on Artificial Intelligence) have shown that TM can be improved by introducing external knowledge, where they leverage pre-trained word embeddings (i.e. local view) only. However, the word embeddings ignore the thematically contextualized structures (i.e., document-level semantics), and cannot deal with ambiguity.

Further, knowledge transfer via word embeddings is vulnerable to negative transfer (Cao et al., 2010, Adaptive transfer learning. In Proceedings of the Twenty-Fourth AAAI Conference on Artificial Intelligence, AAAI 2010, Atlanta, Ga., USA, July 11-15,2010. AAAI Press) on the target domain when domains are shifted and not handled properly. For instance, consider a short-text document ν: [apple gained its US market shares] in the target domain T. Here, the word “apple” refers to a company, and hence the word vector of apple (about fruit) is an irrelevant source of knowledge transfer for both the document νand its topic Z.

### SUMMARY

The object of the present invention is to overcome or at least alleviate these problems by providing a Computer-implemented method of Neural Topic Modelling (NTM) according to independent claim 1 as well as a respective computer program, a respective computer-readable medium and a respective data processing system according to the further independent claims. Further refinements of the present invention are subject of the dependent claims.

According to a first aspect of the present invention a computer-implemented method of Neural Topic Modelling (NTM) in an autoregressive Neural Network (NN) using Global-View Transfer (GVT) for a probabilistic or neural autoregressive topic model of a target T given a document νof words νᵢ, i=1 . . . D, comprises the steps of: preparing a pre-trained topic Knowledge Base (KB), transferring knowledge to the target T by GVT and minimising an extended loss function [symbol] _{reg} (ν). In the step of preparing the pre-trained topic (KB), the pre-trained topic (KB) of latent topic features Z^{k} ∈ [symbol] ^{H×K} is prepared, where k indicates the number of a source S^{k} , k≥1, of the latent topic feature, H indicates the dimension of the latent topic and K indicates a vocabulary size. In the step of transferring knowledge to the target T by GVT, knowledge is transferred to the target T by GVT via learning meaningful latent topic features guided by relevant latent topic features Z^{k} of the topic KB. The step of transferring knowledge to the target T by GVT comprises the sub-step extending a loss function [symbol] (ν). In the step of extending the loss function [symbol] (ν), the loss function [symbol] (ν) of the probabilistic or neural autoregressive topic model for the document νof the target T, which loss function [symbol] (ν) is a negative log-likelihood of joint probabilities p(νᵢ|ν_{<i}) of each word νᵢ in the autoregressive NN, which probabilities p(νᵢ|ν_{<i}) for each word νᵢ are based on the probabilities of the preceding words ν_{<i}, is extended with a regularisation term comprising weighted relevant latent topic features Z^{k} to form an extended loss function [symbol] _{reg}(ν). In the step of minimising the extended loss function [symbol] _{reg}(ν), the extended loss function [symbol] _{reg} (ν) is minimised to determine a minimal overall loss.

According to a second aspect of the present invention a computer program comprises instructions which, when the program is executed by a computer, cause the computer to carry out the steps of the method according to the first aspect of the present invention.

According to a third aspect of the present invention a computer-readable medium has stored thereon the computer program according to the second aspect of the present invention.

According to a fourth aspect of the present invention a data processing system comprises means for carrying out the steps of the method according to the first aspect of the present invention.

The probabilistic or neural autoregressive topic model (model in the following) is arranged and configured to determine a topic of an input text or input document νlike a short text, article, etc. The model may be implemented in a Neural Network (NN) like a Deep Neural Network (DNN), a Recurrent Neural Network (RNN), a Feed Forward Neural Network (FFNN), a Convolutional Neural Network (CNN), a Long-Short-Term Memory network (LSTM), a Deep Believe Network (DBN), a Large Memory Storage And Retrieval neural network (LAMSTAR), etc.

The NN may be trained on determining the content and or topic of input documents ν. Any training method may be used to train the NN. In particular, a Glove algorithm (Pennington et al., 2014, Glove: Global vectors for word representation. In Proceedings of the 2014 Conference on Empirical Methods in Natural Language Processing (EMNLP), pages 1532-1543. Association for Computational Linguistics) may be used for training the NN.

The document νcomprises words ν₁ . . . ν_{D} where the number of words D is greater than 1. The model determines, word by word, the joint probabilities or rather autoregressive conditionals p(νᵢ|ν_{<i}) of each word νᵢ. Each of the joint probabilities p(νᵢ|ν_{<i}) may be modelled by a FFNN using the probabilities of respective preceding words ν_{<i}∈{ν₁, . . . , νᵢ₋₁} in the sequence of the document ν. Thereto, a non-linear activation function g(·), like a sigmoid function, a hyperbolic tangent (tanh) function, etc., and at least one weight matrix, preferably two weight matrices, in particular an encoding matrix W∈ [symbol] ^{H×K} and a decoding matrix U∈ [symbol] ^{K×H} may be used by the model to calculate each probability p(νᵢ|ν_{<i}).

The probabilities p(νᵢ|ν_{<i}) are joined into a joint distribution p(ν)=fr_{—l}p(νᵢ|ν_{<i}) and the loss function [symbol] (ν), which is a negative log-likelihood of the joint distribution p(ν), is provided as [symbol] (ν)=log(p(ν)).

The knowledge transfer is based on the topic KB of pre-trained latent topic features Z^{k}={Z¹, . . . , Z^{|S|}} from the at least one source S^{k}, k≥1. A latent topic feature Z^{k} comprises a set of words that belong to the same topic, like exemplarily {profit, growth, stocks, apple, fall, consumer, buy, billion, shares} [symbol] Trading. The topic KB, thus, comprises global information about topics. For the GVT the regularisation term is added to the loss function [symbol] (ν), resulting in the extended loss function [symbol] _{reg} (ν). Thereby, information from the global view of topics is transferred to the model. The regularisation term is based on the topic features Z^{k} and may comprise a weight γ^{k} that governs the degree of imitation of topic features Z^{k}, an alignment matrix A^{k} ∈ [symbol] ^{H×H} that aligns the latent topics in the target T and in the k^{th} source S^{k} and the encoding matrix W. Thereby, the generative process of learning meaningful (latent) topic features , in particular in W, is guided by relevant features in {Z}₁^{|S|}.

Finally, the extended loss function [symbol] _{reg}(ν) or rather overall loss is minimised (e.g. gradient descent, etc.) in a way that the (latent) topic features Z^{k} in W simultaneously inherit relevant topical features from the at least one source S^{k}, and generate meaningful representations for the target T.

Given that the word and topic representations encode complementary information, no prior work has considered knowledge transfer via (pre-trained latent) topics (i.e. GVT) in large corpora.

With GVT the thematic structures (topical semantics) in the underlying corpus (target T) is captured. This leads to a more reliable determination of the topic of the input document ν.

According to a refinement of the present invention the probabilistic or neural autoregressive topic model is a DocNADE architecture.

DocNADE (Larochelle and Lauly, 2012, A neural autoregressive topic model. In Advances in Neural Information Processing Systems 25: 26th Annual Conference on Neural Information Processing Systems, pages 2717-2725) is an unsupervised NN-based probabilistic or neural autoregressive topic model that is inspired by the benefits of NADE (Larochelle and Murray, 2011, The neural autoregressive distribution estimator. In Proceedings of the Fourteenth International Conference on Artificial Intelligence and Statistics, AISTATS, volume 15 of JMLR Proceedings, pages 29-37. JMLR.org) and RSM (Salakhutdinov and Hinton, 2009, Replicated softmax: an undirected topic model. In Advances in Neural Information Processing Systems 22: 23rd Annual Conference on Neural Information Processing Systems, pages 1607-1614. Curran Associates, Inc.) architectures. RSM has difficulties due to intractability leading to approximate gradients of the negative log-likelihood [symbol] (ν), while NADE does not require such approximations. On other hand, RSM is a generative model of word count, while NADE is limited to binary data. Specifically, DocNADE factorizes the joint probability distribution p(ν) of words ν₁ . . . ν_{D} in the input document νas a product of the probabilities or conditional distributions p(νᵢ|ν_{<i}) and models each probability via a FFNN to efficiently compute a document representation.

For the input document ν=(ν₁, . . . , ν_{D}) of size D, each word νᵢ takes a value {1, . . . , K} of the vocabulary of size K. DocNADE learns topics in a language modelling fashion (Bengio et al., 2003, A neural probabilistic language model. Journal of Machine Learning Research, 3:1137-1155) and decomposes the joint distribution p(ν) such that each probability or autoregressive conditional p(νᵢ|ν_{<i}) is modelled by the FFNN using the respective preceding words ν_{<i} in the sequence of the input document ν:

$$p ( {v}_{i} = w \vert {v}_{< i} ) = \frac{exp ( {b}_{w} + {U}_{w , :} {h}_{i} ( {v}_{< i} ) )}{{\sum }_{{w}^{′}} exp ( {b}_{{w}^{′}} + {U}_{{w}^{′} , :} {h}_{i} ( {v}_{< i} ) )}$$

where hᵢ(ν_{<i}) is a probability function:

hᵢ(v_{<i})=g(c+Σ_{q<i}W_{:,v}_{_{q}})

where i∈{1, . . . , D}, ν_{<i} is the sub-vector consisting of all ν_{g} such that q<i, i.e. ν_{<i}∈{ν₁, . . . , νᵢ₋₁}, g(·) is the non-linear activation function and c∈ [symbol] ^{H} and b∈ [symbol] ^{K} are bias parameter vectors (c may be a pre-activation α, see further below).

With DocNADE the extended loss function [symbol] _{reg}(ν) is given by:

[symbol]

_{reg}(ν)=−log(p(ν))+Σₖ₌₁^{|S|}γ^{k}Σⱼ₌₁^{H}∥A_{j,;}^{k}W−Zⱼ^{k}∥₂²

where A^{k}∈ [symbol] ^{H×H} is the alignment matrix, γ^{k} is the weight for Z^{k} and governs the degree of imitation of topic features Z^{k} by W in T and j indicates the topic (i.e. row) index in the topic matrix Z^{k}.

According to a refinement of the present invention Multi-View Transfer (MVT) is used by additionally using Local-View Transfer (LVT), where the computer-implemented method further comprises the primary steps preparing a pre-trained word embeddings KB and transferring knowledge to the target T by LVT. In the step of preparing the pre-trained word embeddings KB, the pre-trained word embeddings KB of word embeddings E^{k}∈ [symbol] ^{E×K} is preppared, where E indicates the dimension of the word embedding. In the step of transferring knowledge to the target T by LVT, knowledge is transferred to the target T by LVT via learning meaningful word embeddings guided by relevant word embeddings E^{k} of the word embeddings KB. The step of transferring knowledge to the target T by LVT comprises the sub-step extending a term for calculating pre-activations α. In the step of extending a term for calculating the pre-activations α, the pre-activations α of the probabilistic or neural autoregressive topic model of the target T, which pre-activations α control an activation of the autoregressive NN for the preceding words v_{<i} in the probabilities p(νᵢ|ν_{<i}) of each word are extended with weighted relevant latent word embeddings E^{k} to form an extended pre-activation αₑₓₜ.

First word and topic representations on multiple source domains are learned and then via MVT comprising (first) LVT and (then) GVT knowledge is transferred within neural topic modelling by jointly using the complementary representations of word embeddings and topics. Thereto, the (unsupervised) generative process of learning hidden topics of the target domain by word and latent topic features from at least one source domain S^{k}, k≥1, is guided such that the hidden topics on the target T become meaningful.

With LVT knowledge transfer to the target T is performed by using the word embeddings KB of pre-trained word embeddings E^{k}={E¹, . . . , E^{|S|}} from at least one source S^{k}, k≥1. A word embedding may be a list of nearest neighbours of a word, like apple [symbol] {apples, pear, fruit, berry, pears, strawberry}. The pre-activations a of the model of the autoregressive NN control if and how strong nodes of the autoregressive NN are activated for each preceding word ν_{<i}. The pre-activations a are extended with relevant word embeddings E^{k} weighted by a weight λ^{k} leading to the extended pre-activations αₑₓₜ.

The extended pre-activations αₑₓₜ in DocNADE are given by:

αₑₓₜ=α+Σₖ₌₁^{|S|}λ^{k}E_{:,ν}_{_{q}}^{k}

And the probability function hᵢ(ν_{<i}) in DocNADE then is given by:

hᵢ(ν_{<i})=g(c+Σ_{q<i}W_{:,ν}_{_{q}}Σ_{q<i}Σₖ₌₁^{|S|}λ^{k}E_{:,84} _{_{q}}^{k})

where c=α, λ^{k} is the weight for E^{k} that controls the amount of knowledge transferred in T, based on domain over lap between target and the at least one source S^{k}.

Thus, there is provided an unsupervised neural topic modelling framework that jointly leverages (external) complementary knowledge, namely latent word and topic features from at least one source S^{k} to alleviate data-sparsity issues. With the computer-implemented method using MVT the document ν can be better modelled and noisy topics Z can be amended for coherence, given meaningful word and topic representations.

According to a refinement of the present invention, Multi-Source Transfer (MST) is used, wherein the latent topic features Z^{k}∈ [symbol] ^{H×K} of the topic KB and alternatively or additionally the word embeddings E^{k} ∈ [symbol] ^{E×K} of the word embeddings KB stem from more than one source S^{k}, k>1.

A latent topic feature Z^{k} comprises a set of words that belong to the same topic. Often, there are several topic-word associations in different domains (e.g. in different topics Z₁-Z₄, with Z₁ (S¹): {profit, growth, stocks, apple, fall, consumer, buy, billion, shares} [symbol] Trading; Z₂(S²): {smartphone, ipad, apple, app, iphone, devices, phone, tablet} [symbol] Product Line; Z₃(S³): {microsoft, mac, linux, ibm, ios, apple, xp, windows} [symbol] Operating System/Company; Z₄(S⁴): {apple, talk, computers, shares, disease, driver, electronics, profit, ios} [symbol] ?). Given a noisy topic (e.g. Z₄) and meaningful topics (e.g. Z₁-Z₃) multiple relevant (source) domains have to be identified and their word and topic representations be transferred in order to facilitate meaningful learning in a sparse corpus. To better deal with polysemy and alleviate data sparsity issues, GVT with latent topic features (thematically contextualized) and optionally LVT with word embeddings in MST from multiple sources or source domains S^{k}, k≥1, are utilised.

Topic alignments between target T and sources S^{k} need to be done. For example in the Doc-NADE architecture, in the extended loss function [symbol] _{reg} (ν) j indicates the topic (i.e. row) index in a latent topic matrix Z^{k}. For example, a first topic Zⱼ₌₁¹∈Z¹ of the first source S¹ aligns with a first row-vector (i.e. topic) of W of the target T. However, other topics, e.g. Zⱼ₌₂¹∈Z¹ and Zⱼ₌₃¹∈Z¹, need alignment with the target topics. When LVT and GVT are performed in MVT for many sources S^{k}, the two complementary representations are jointly used in knowledge transfer using both advantages of MVT and of MST.

In the following an exemplary computer program according to the second aspect of the present invention is given as exemplary algorithm in pseudo-code, which comprises instructions, corresponding to the steps of the computer-implemented method according to the first aspect of the present invention, to be executed by data-processing means (e.g. computer) according to the fourth aspect of the present invention:

```
Input: one target training document v, k = |S| sources /source domains S^{k}
Input: topic KB of latent topics {Z₁, . . . , Z_{|S|}
Input: word embeddings KB of word embedding matrices {E₁, . . . , E_{|S|}
Parameters: Θ = {b, c, W, U , A₁, . . . A|_{S|}}
Hyper-parameters: θ = {λ₁, . . . , λ_{|S|}, γ₁, . . . , γ_{|S|}, H}
Initialize: a [symbol]   c and p(v) [symbol]   1
for i from 1 to D do
  hᵢ(v_{<i}) [symbol]   g(v_{<i}), where g = {sigmoid, tanh}
  $p ( {v}_{i} = w \text{\textbar} {v}_{< i} ) = \frac{exp ( {b}_{w} + {U}_{w , :} {h}_{i} ( {v}_{< i} ) )}{{\sum }_{{w}^{′}} exp ( {b}_{{w}^{′}} + {U}_{{w}^{′} , :} {h}_{i} ( {v}_{< i} ) )}$
  p(v) [symbol]   p(v)p(vᵢ|v_{<i})
  compute pre-activation at step, i: a [symbol]   a + W_{:,v}_{_{q}}
  if LVT then
    get word embedding for vᵢ from source domains S^{k}
    aₑₓₜ [symbol] a + Σₖ₌₁^{|S|} λ^{k}E_{:,v}_{_{q}}^{k} [symbol]
(v) [symbol]   −log(p(v))
if GVT then [symbol]
  _{reg}(v) [symbol] [symbol]     (v) + Σₖ₌₁^{|S|}γ^{k} Σⱼ₌₁^{H}∥Aⱼ^{k,:}W −Zⱼ^{k}∥₂²
```

### BRIEF DESCRIPTION

The present invention and its technical field are subsequently explained in further detail by exemplary embodiments shown in the drawings. The exemplary embodiments only conduce better understanding of the present invention and in no case are to be construed as limiting for the scope of the present invention. Particularly, it is possible to extract aspects of the subject-matter described in the figures and to combine it with other components and findings of the present description or figures, if not explicitly described differently. Equal reference signs refer to the same objects, such that explanations from other figures may be supplementally used.

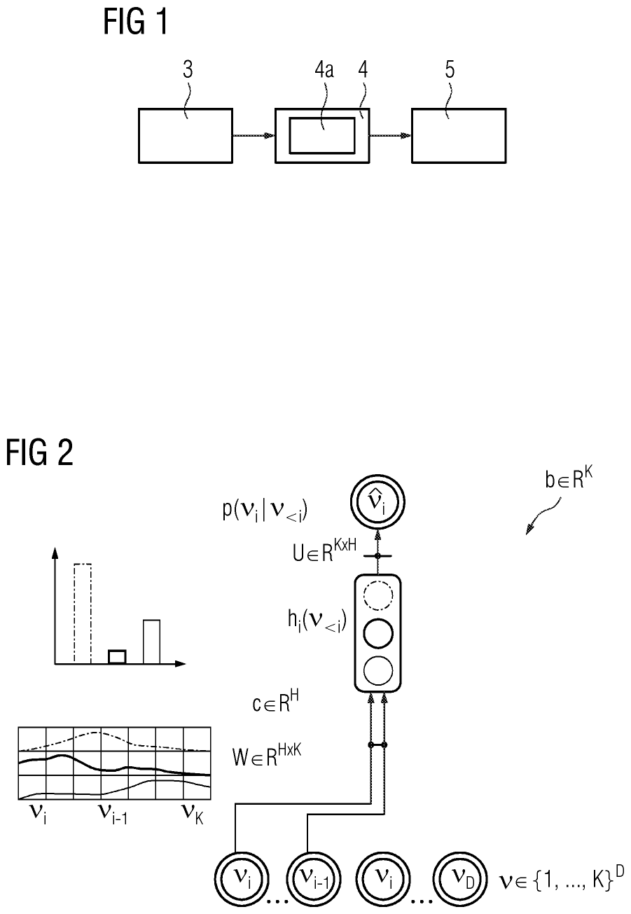

FIG. 1 shows s schematic flow chart of an embodiment of the computer-implemented method according to the first aspect of the present invention using GVT.

FIG. 2 shows a schematic overview of the embodiment of the computer-implemented method according to the first aspect of the present invention using GVT of FIG. 1.

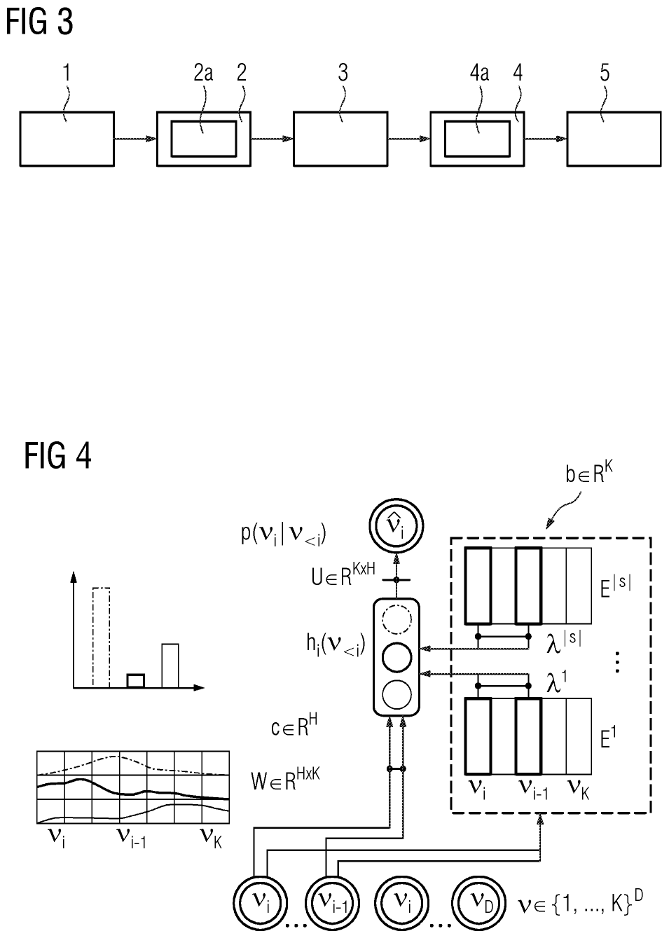

FIG. 3 shows s schematic flow chart of an embodiment of the computer-implemented method according to the first aspect of the present invention using MVT.

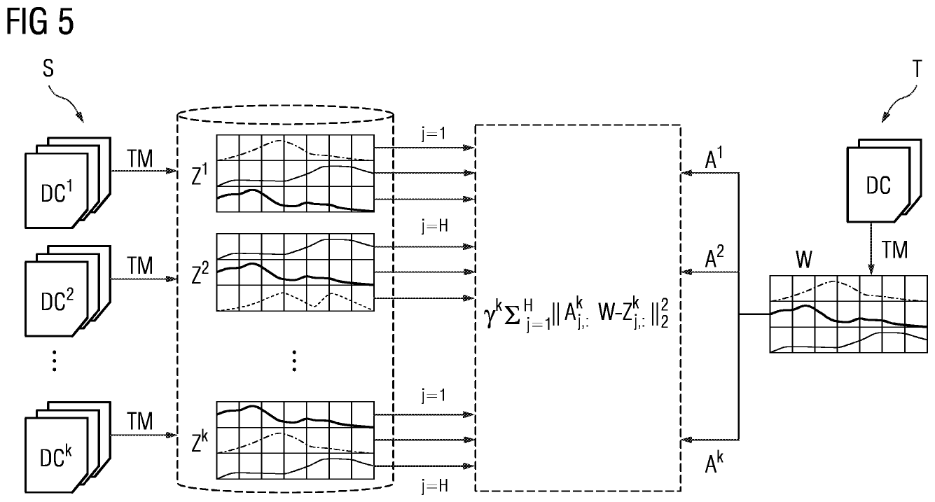

FIG. 4 shows a schematic overview of the embodiment of the computer-implemented method according to the first aspect of the present invention using MVT of FIG. 3.

FIG. 5 shows a schematic overview of an embodiment of the computer-implemented method according to the first aspect of the present invention using GVT or MVT and using MST.

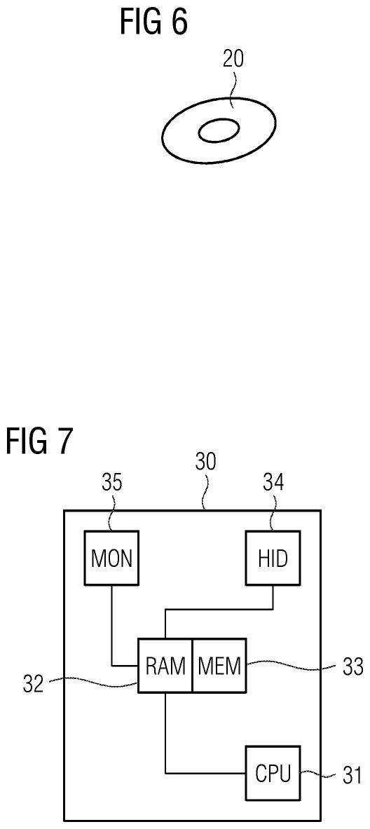

FIG. 6 shows a schematic view of a computer-readable medium according to the third aspect of the present invention.

FIG. 7 shows a schematic view of a data processing system according to the fourth aspect of the present invention.

### DETAILED DESCRIPTION

In FIG. 1 a flowchart of an exemplary embodiment of the computer-implemented method of Neural Topic Modelling (NTM) in an autoregressive Neural Network (NN) using Global-View Transfer (GVT) for a probabilistic or neural autoregressive topic model of a target T given a document νof words νᵢ according to the first aspect of the present invention is schematically depicted. The steps of the computer-implemented method are implemented in the computer program according to the second aspect of the present invention. The probabilistic or neural autoregressive topic model is a DocNADE architecture (DocNADE model in the following). The document ν comprises D words, D≥1.

The computer-implemented method comprises the steps of preparing (3) a pre-trained topic Knowledge Base (KB), transferring (4) knowledge to the target T by GVT and minimising (5) an extended loss function [symbol] _{reg} (ν). The step of transferring (4) knowledge to the target T by GVT comprises the sub-step of extending (4a) a loss function [symbol] (ν).

In the step of preparing (3) a pre-trained topic KB, pre-trained latent topic features Z^{k}={Z¹, . . . , Z^{|S|}} from the at least one source S^{k} , k≥1, are prepared and provided as the topic KB to the DocNADE model.

In the step of transferring (4) knowledge to the target T by GVT, the prepared topic KB is used to provide information from a global view about topics to the DocNADE model. This transfer of information from the global view of topics to the DocNADE model is done in the sub-step of extending (4a) the loss function [symbol] (ν) by extending the loss function [symbol] (ν) of the DocNADE model with a regularisation term. The loss function [symbol] (ν) is a negative log-likelihood of a joint probability distribution p(ν) of the words ν₁ . . . ν_{D} of the document ν. The joint probability distribution p(ν) is based on probabilities or autoregressive conditionals p(νᵢ|ν_{<i}) for each word ν₁ . . . ν_{D}. The autoregressive conditionals p(νᵢ|ν_{<i}) include the probabilities of the preceding words ν_{<i}. A non-linear activation function g(·), like a sigmoid function, a hyperbolic tangent (tanh) function, etc., and two weight matrices, an encoding matrix W∈ [symbol] ^{H×K} (encoding matrix of the Doc-NADE model) and a decoding matrix U∈ [symbol] ^{K×H} (decoding matrix of the DocNADE model), are used by the DocNADE model to calculate each probability p(νᵢ|ν_{<i}).

$$ℒ ( v ) = - log ( p ( v ) ) = - log ( {\prod }_{i = 1}^{D} p ( {v}_{i} \vert {v}_{< i} ) )$$

$$with$$

$$p ( {v}_{i} = w \vert {v}_{< i} ) = \frac{exp ( {b}_{w} + {U}_{w , :} {h}_{i} ( {v}_{< i} ) )}{{\sum }_{{w}^{′}} exp ( {b}_{{w}^{′}} + {U}_{{w}^{′} , :} {h}_{i} ( {v}_{< i} ) )}$$

where hᵢ(ν_{<i}) is a probability function:

hᵢ(ν_{<i})=g(c+Σ_{q<i}W_{:,ν}_{_{q}})

where i∈{1, . . . , D}, ν_{<i} is the sub-vector consisting of all ν_{q} such that q<i, i.e. ν_{21 i}∈{ν₁, . . . , νᵢ₋₁}, g(·) is the non-linear activation function and c∈ [symbol] ^{H} and b∈ [symbol] ^{K} are bias parameter vectors, in particular, c is a pre-activation a (see further below).

The loss function [symbol] (ν) is extended with an regularisation term which is based on the topic features Z^{k} and comprises a weight λ^{k} that governs the degree of imitation of topic features Z^{k}, an alignment matrix A^{k}∈ [symbol] ^{H×H} that aligns the latent topics in the target T and in the k^{th} source S^{k} and the encoding matrix W of the DocNADE model.

[symbol]

_{reg}(ν)=−log(p(ν))+Σₖ₌₁^{|S|}λ^{k}Σⱼ₌₁^{H}∥A_{j,:}^{k}W−Zⱼ^{k}∥₂²

In the step of minimising (5) the extended loss function [symbol] _{reg}(ν), the extended loss function [symbol] _{reg}(ν) is minimised. Here, the minimising can be done via a gradient descent method or the like.

In FIG. 2 the GVT of the embodiment of the computer-implemented method of FIG. 1 is schematically depicted.

The input document ν of words ν₁, . . . , ν_{D} (visible units) is stepped word by word by the Doc-NADE model. The ??? hᵢ(ν_{<i}) of the preceding words ν_{<i} is determined by the DocNADE model using the bias parameter c (hidden bias). Based on the ??? hᵢ(ν_{<i}), the decoding matrix U and the bias parameter b the probability or rather autoregressive conditional p(νᵢ=w|ν_{<i}) for each of the words ν₁, . . . , ν_{D} is calculated by the DocNADE model.

As schematically depicted in FIG. 2 for each word νᵢ, i=1 . . . D, different topics (here exemplarily Topic#1, Topic#2, Topic#3) have a different probability. The probabilities of all words ν₁, . . . , ν_{D} are combined and, thus, the most probable topic of the input document ν is determined.

In FIG. 3 a flowchart of an exemplary embodiment of the computer-implemented method according to the first aspect of the present invention using Multi-View Transfer (MVT) is schematically depicted. This embodiment corresponds to the embodiment of FIG. 1 using GVT and is extended by Local-View Transfer (LVT). The steps of the computer-implemented method are implemented in the computer program according to the second aspect of the present invention.

The computer-implemented method comprises the steps of the method of FIG. 1 and further comprises the primary steps of preparing (1) a pre-trained word embeddings KB and transferring (2) knowledge to the target T by LVT. The step of transferring (2) knowledge to the target T by LVT comprises the sub-step of extending (2a) pre-activations α.

In the step of preparing (1) the pre-trained word embeddings KB, pre-trained word embeddings E^{k}={E¹, . . . , E^{|S|}} from the at least one source S^{k}, k≥1, are prepared and provided as the word embeddings KB to the DocNADE model.

In the step of transferring (2) knowledge to the target T by LVT, the prepared word embeddings KB is used to provide information from a local view about words to the DocNADE model. This transfer of information from the local view of word embeddings to the DocNADE model is done in the sub-step of extending (2a) the pre-activations α. The pre-activations a are extended with relevant word embeddings features E^{k} weighted by a weight λ^{k} leading to the extended pre-activations αₑₓₜ.

The extended pre-activations αₑₓₜ in the DocNADE model are given by:

αₑₓₜ=α+Σₖ₌₁^{|S|}λ^{k}E_{:,ν}_{_{q}}^{k}

And the probability function hᵢ(ν_{<i}) in the DocNADE model then is given by:

hᵢ(ν_{<i})=g(c+Σ_{q<i}W_{:,ν}_{_{q}}+Σ_{q<i}Σₖ₌₁^{|S|}λ^{k}E_{:,ν}_{_{q}}^{k})

where c=α, λ^{k} is the weight for E^{k} that controls the amount of knowledge transferred in T, based on domain over lap between target and the at least one source S^{k}.

In FIG. 4 the MVT by using first LTV and then GVT of the embodiment of the computer-implemented method of FIG. 3 is schematically depicted. FIG. 4 corresponds to FIG. 2 extended by LTV.

For each word νᵢ of the input document νthe relevant word embedding E^{k} is selected and introduced into the probability function hᵢ(ν_{<i}) weighted with a specific λ^{k} by extending the respective pre-activation α which is set as the bias parameter c.

In FIG. 5 Multi-Source Transfer (MST) used in the embodiment of the computer-implemented method of FIG. 1 or of FIG. 3 is schematically depicted.

Multiple sources S^{k} in form of source corpuses DC^{k} contain latent topic features Z^{k} and optionally word embeddings E^{k} (not depicted). Topic alignments between target T and sources S^{k} need to be done in MST. Each row in a latent topic feature Z^{k} is a topic embedding that explains the underlying thematic structures of the source corpus DC^{k}. Here, TM refers to a DocNADE model. In the extended loss function [symbol] _{reg} (ν) of the DocNADE model j indicates the topic (i.e. row) index in a latent topic matrix Z^{k}. For example, a first topic Zⱼ₌₁¹∈Z¹ of the first source S¹ aligns with a first row-vector (i.e. topic) of W of the target T. However, other topics, e.g. Zⱼ₌₂¹∈Z¹ and Zⱼ₌₃¹∈Z¹, need alignment with the target topics.

In FIG. 6 an embodiment of the computer-readable medium 20 according to the third aspect of the present invention is schematically depicted.

Here, exemplarily a computer-readable storage disc 20 like a Compact Disc (CD), Digital Video Disc (DVD), High Definition DVD (HD DVD) or Blu-ray Disc (BD) has stored thereon the computer program according to the second aspect of the present invention and as schematically shown in FIGS. 1 to 5. However, the computer-readable medium may also be a data storage like a magnetic storage/memory (e.g. magnetic-core memory, magnetic tape, magnetic card, magnet strip, magnet bubble storage, drum storage, hard disc drive, floppy disc or removable storage), an optical storage/memory (e.g. holographic memory, optical tape, Tesa tape, Laserdisc, Phase-writer (Phasewriter Dual, PD) or Ultra Density Optical (UDO)), a magneto-optical storage/memory (e.g. MiniDisc or Magneto-Optical Disk (MO-Disk)), a volatile semiconductor/solid state memory (e.g. Random Access Memory (RAM), Dynamic RAM (DRAM) or Static RAM (SRAM)), a non-volatile semiconductor/solid state memory (e.g. Read Only Memory (ROM), Programmable ROM (PROM), Erasable PROM (EPROM), Electrically EPROM (EEPROM), Flash-EEPROM (e.g. USB-Stick), Ferroelectric RAM (FRAM), Magnetoresistive RAM (MRAM) or Phase-change RAM).

In FIG. 7 an embodiment of the data processing system 30 according to the fourth aspect of the present invention is schematically depicted.

The data processing system 30 may be a personal computer (PC), a laptop, a tablet, a server, a distributed system (e.g. cloud system) and the like. The data processing system 30 comprises a central processing unit (CPU) 31, a memory having a random access memory (RAM) 32 and a non-volatile memory (MEM, e.g. hard disk) 33, a human interface device (HID, e.g. keyboard, mouse, touchscreen etc.) 34 and an output device (MON, e.g. monitor, printer, speaker, etc.) 35. The CPU 31, RAM 32, HID 34 and MON 35 are communicatively connected via a data bus. The RAM 32 and MEM 33 are communicatively connected via another data bus. The computer program according to the second aspect of the present invention and schematically depicted in FIGS. 1 to 3 can be loaded into the RAM 32 from the MEM 33 or another computer-readable medium 20. According to the computer program the CPU executes the steps 1 to 5 or rather 3 to 5 of the computer-implemented method according to the first aspect of the present invention and schematically depicted in FIGS. 1 to 5. The execution can be initiated and controlled by a user via the HID 34. The status and/or result of the executed computer program may be indicated to the user by the MON 35. The result of the executed computer program may be permanently stored on the non-volatile MEM 33 or another computer-readable medium.

In particular, the CPU 31 and RAM 33 for executing the computer program may comprise several CPUs 31 and several RAMs 33 for example in a computation cluster or a cloud system. The HID 34 and MON 35 for controlling execution of the computer program may be comprised by a different data processing system like a terminal communicatively connected to the data processing system 30 (e.g. cloud system).

Although specific embodiments have been illustrated and described herein, it will be appreciated by those of ordinary skill in the art that a variety of alternate and/or equivalent implementations exist. It should be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

In the foregoing detailed description, various features are grouped together in one or more examples for the purpose of streamlining the disclosure. It is understood that the above description is intended to be illustrative, and not restrictive. It is intended to cover all alternatives, modifications and equivalents as may be included within the scope of the invention. Many other examples will be apparent to one skilled in the art upon reviewing the above specification.

Specific nomenclature used in the foregoing specification is used to provide a thorough understanding of the invention. However, it will be apparent to one skilled in the art in light of the specification provided herein that the specific details are not required in order to practice the invention. Thus, the foregoing descriptions of specific embodiments of the present invention are presented for purposes of illustration and description. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Throughout the specification, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on or to establish a certain ranking of importance of their objects. In the context of the present description and claims the conjunction “or” is to be understood as including (“and/or”) and not exclusive (“either . . . or”).

### LIST OF REFERENCE SIGNS

1 preparing the pre-trained word embeddings KB of word embeddings

2 transferring knowledge to the target by LVT

2a extending a term for calculating pre-activations

3 preparing the pre-trained topic KB of latent topic features

4 transferring knowledge to the target by GVT

4a extending the loss function

5 minimising the extended loss function

20 computer-readable medium

30 data processing system

31 central processing unit (CPU)

32 random access memory (RAM)

33 non-volatile memory (MEM)

34 human interface device (HID)

35 output device (MON)

1. A computer-implemented method of Neural Topic Modelling, NTM, in an autoregressive Neural Network, NN, using Global-View Transfer, GVT, for a probabilistic or neural autoregressive topic model of a target T given a document νof words νᵢ, i=1, . . . D, comprising the steps:
preparing a pre-trained topic Knowledge Base, KB, of latent topic features Z^{k} ∈ [symbol] ^{H×K}, where k indicates the number of a source S^{k} , k≥1, of the latent topic feature, H indicates the dimension of the latent topic and K indicates a vocabulary size;
transferring knowledge to the target T by GVT via learning meaningful latent topic features guided by relevant latent topic features Z^{k} of the topic KB, comprising the sub-step:
extending a loss function [symbol] (ν) of the probabilistic or neural autoregressive topic model for the document ν of the target T, which loss function [symbol] (ν) is a negative log-likelihood of j oint probabilities p(νᵢ|νν_{<i}) of each word νᵢ in the autoregressive NN which probabilities p(νᵢ|ν_{<i}) for each word νᵢ are based on the preceding words ν_{<i}, with a regularisation term comprising weighted relevant latent topic features Z^{k} to form a extended loss function [symbol] _{reg}(ν);
and
minimising the extended loss function [symbol] _{reg} (ν) to determine a minimal overall loss.

2. The computer-implemented method according to claim 1, wherein the probabilistic or neural autoregressive topic model is a DocNADE architecture.

3. The computer-implemented method according to claim 1, using Multi-View Transfer, MVT, by additionally using Local-View Transfer, LVT, further comprising the primary steps:
preparing a pre-trained word embeddings KB of word embeddings E^{k}∈ [symbol] ^{E×K}, where E indicates the dimension of the word embedding;
transferring knowledge to the target T by LVT via learning meaningful word embeddings guided by relevant word embeddings E^{k} of the word embeddings KB, comprising the sub-step:
extending a term for calculating pre-activations α of the probabilistic or neural autoregressive topic model of the target T, which pre-activations α control an activation of the autoregressive NN for the preceding words ν_{<i} in the probabilities p(νᵢ|ν_{<i}) of each word νᵢ, with weighted relevant latent word embeddings E^{k} to form an extended pre-activation αₑₓₜ.

4. The computer-implemented method according to claim 1 using Multi-Source Transfer, MST, wherein the latent topic features Z^{k}∈ [symbol] ^{H×K} of the topic KB and/or the word embeddings E^{k}∈ [symbol] ^{E×K} of the word embeddings KB stem from more than one source S^{k}, k>1.

5. The computer program comprising instructions which, when the program is executed by a computer, cause the computer to carry out the steps of the method according to claim 1.

6. The computer-readable medium having stored thereon the computer program according to claim 5.

7. A data processing system comprising means for carrying out the steps of the method according to claim 1.
